(19) United States
(12) Patent Application Publication
(10) Pub. No.: US 2025/0083956 A1
(43) Pub. Date: Mar. 13, 2025

(54) LOW CONCENTRATION OZONE GAS SUPPLY DEVICE

(71) Applicant: SKY TECH INC., Hsinchu County (TW)

(72) Inventors: JUNG-HUA CHANG, Hsinchu County (TW); CHING-LIANG YI, Hsinchu County (TW); Ta-Hao Kuo, Hsinchu County (TW)

(21) Appl. No.: 18/367,437

(22) Filed: Sep. 12, 2023

(51) Int. Cl. C01B 13/11

(52) U.S. Cl. CPC C01B 13/11; C01B 2201/64; C01B 2201/90

(57) ABSTRACT

A low concentration ozone gas supply device includes an ozone dilution tank, an ozone generator, a dilution gas supplier, and plural gas reservoir. The ozone dilution tank is provided with a dilution space, and the ozone dilution tank is provided with an overflow vent connected to the dilution space. The ozone generator is configured to continuously supply ozone to the dilution space of the ozone dilution tank. The dilution gas supplier is configured to supply a dilution gas to the dilution space, so that the ozone is mixed with the dilution gas in the dilution space to form the low concentration ozone gas, and the low concentration ozone gas in the dilution space continuously overflows via the overflow vent. The gas reservoirs are connected to the dilution space; wherein the volume of the dilution space is larger than the sum of the volumes of gas reservoirs.

### BACKGROUND

### Technical Field

This disclosure relates to ozone supply in a semiconductor manufacturing process, in particular to a low concentration ozone gas supply device.

### Related Art

Ozone gas is often used in CVD/ALD processes, especially for cleaning wafer surfaces to remove contaminants from the wafer surface. However, in some processes, important functional groups are sometimes present on the wafer surface, and these functional groups will be used in subsequent processes. These functional groups are easily damaged by reaction with ozone. At the time, a lower concentration ozone gas is required to be injected into the reaction chamber to avoid damage to the functional groups.

Dilution of ozone is accomplished by coupling the ozone generator to a dilution gas (O2 or Ar) supply source, a mass flow controller is used to control the output of the dilution gas, so that the ozone is diluted by the dilution gas to produce a low concentration ozone gas. However, this mechanism is prone to unstable flow and concentration of ozone gas, making it difficult to control the ozone in the reaction chamber.

### SUMMARY

In view of the above problem, this disclosure provides a low concentration ozone gas supply device, to provide a stable supply of low concentrations ozone gas to one or more reaction chambers.

This disclosure provides a low concentration ozone gas supply device, for supplying low concentration ozone gas to a plurality of reaction chambers includes an ozone dilution tank, an ozone generator, a dilution gas supplier, and a plurality of gas reservoir. The ozone dilution tank is provided with a dilution space defined therein, and the ozone dilution tank is provided with an overflow vent connected to the dilution space. The ozone generator is configured to continuously supply ozone to the dilution space of the ozone dilution tank. The dilution gas supplier is configured to supply a dilution gas to the dilution space, so that the ozone is mixed with the dilution gas in the dilution space to form the low concentration ozone gas, and the low concentration ozone gas in the dilution space continuously overflows via the overflow vent. The gas reservoirs are connected to the dilution space; wherein the volume of the dilution space is larger than the sum of the volumes of the gas reservoirs.

In one or more embodiments, the ozone dilution tank is provided with an ozone receiving vent, and the ozone generator is connected to the ozone receiving vent.

In one or more embodiments, the ozone generator is connected to an oxygen source for receiving oxygen, and the ozone generator provides a high-voltage electric field within the ozone generator to convert the oxygen into ozone.

In one or more embodiments, the ozone dilution tank includes a dilution gas receiving vent and the dilution gas supply is connected to the dilution gas receiving vent.

In one or more embodiments, depending on the mass flow rate of ozone supplied by the ozone generator, the dilution gas supplier supplies the dilution gas to the dilution space at a predetermined mass flow rate, such that a mass percentage concentration of the ozone in the low concentration ozone gas is less than 10%.

In one or more embodiments, the dilution gas supplier includes a dilution gas source and a mass flow controller, the dilution gas source is configured to supply the dilution gas, and the mass flow controller is connected to the dilution gas source to control the mass flow rate of the dilution gas flowing from the dilution gas source into the dilution space.

In one or more embodiments, the dilution gas is oxygen, the dilution gas source of the dilution gas supplier is an oxygen source, and the ozone generator receives oxygen from the oxygen source.

In one or more embodiments, the ozone dilution tank is provided with an ozone pressure gauge. configured to monitor the pressure in the dilution space so as to adjust the flow rate of ozone and dilution gas.

In one or more embodiments, the volume of the dilution space is larger than the sum of the volumes of the gas reservoirs plus a margin, and the margin is larger than 10% of that sum.

In one or more embodiments, each of the gas reservoirs is connected to one corresponding reaction chamber by an ozone supply pipe, for supplying a low concentration ozone gas to the corresponding reaction chamber, and each of the gas reservoirs is of the same volume size and each of the corresponding ozone supply lines is of the same length.

With the low concentration ozone gas supply device proposed by this disclosure, the ozone and dilution gas are first fully mixed in the ozone dilution tank to form a low concentration ozone gas, and then the low concentration ozone gas is used to pressurize the gas reservoirs. The gas reservoir ensures that the low concentration ozone gas injected into the reactor chamber maintains a stable concentration and flow rate, so that the process conditions (e.g., wafer cleaning time and temperature) in the reaction chamber can be more easily controlled, and good process results can be maintained.

### BRIEF DESCRIPTION OF THE DRAWINGS

This disclosure will become more fully understood from the detailed description given herein below for illustration only, and thus not limitative of this disclosure, wherein:

FIG. 1 is a schematic diagram of the piping design of a low concentration ozone gas supply unit and a plurality of reaction chambers in an embodiment of this disclosure.

FIG. 2 is a schematic diagram of the piping design of the low concentration ozone gas supply unit in the embodiment of this disclosure.

FIG. 3 is a schematic diagram of the piping design of the low concentration ozone gas supply unit in the embodiment of this disclosure.

FIG. 4 is a schematic diagram of the piping design of the low concentration ozone gas supply unit in the embodiment of this disclosure.

FIG. 5 is a schematic diagram of the piping design of the low concentration ozone gas supply unit in the embodiment of this disclosure.

FIG. 6 is a schematic diagram of the piping design of the low concentration ozone gas supply unit in the embodiment of this disclosure.

### DETAILED DESCRIPTION

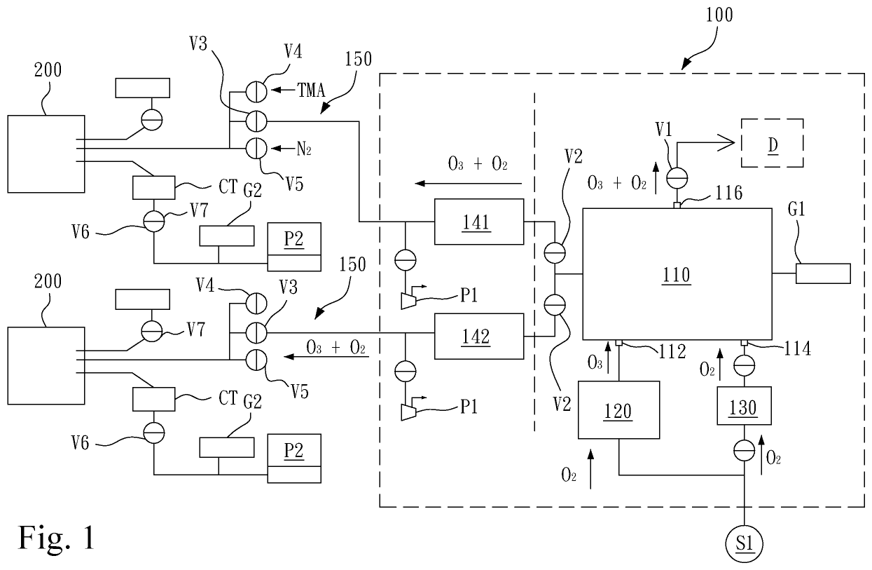

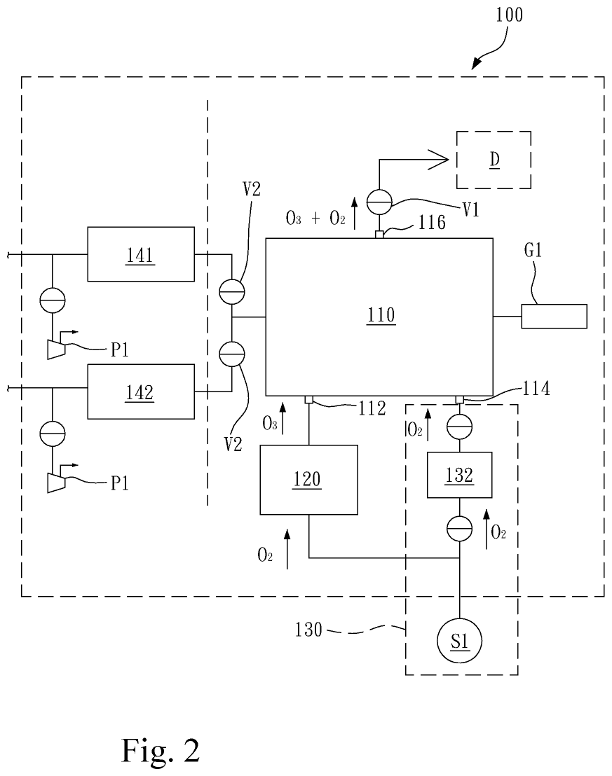

Referring to FIG. 1 and FIG. 2, a low concentration ozone gas supply device 100 according to an embodiment of this disclosure comprises an ozone dilution tank 110, an ozone generator 120, a dilution gas supplier 130, and a plurality of gas reservoirs 141, 142. The low concentration ozone gas supply device 100 is configured to provide a low concentration ozone gas at a stable pressure and a stable flow rate to one or more reaction chambers 200.

As shown in FIG. 1 and FIG. 2, the ozone dilution tank 110 is provided with a dilution space defined therein, and the ozone dilution tank 110 is provided with an ozone receiving vent 112, a dilution gas receiving vent 114 and an overflow vent 116 respectively connected to the dilution space.

As shown in FIG. 1 and FIG. 2, the ozone generator 120 is connected to the ozone receiving vent 112, and the ozone generator 120 is configured to continuously supply ozone to the dilution space of the ozone dilution tank. In detail, the ozone generator 120 is connected to an oxygen source S1 for receiving oxygen (O2). The interior of the ozone generator 120 is provided with a high voltage electric field through electrode plates, such that Oxygen molecules are dissociated into individual oxygen atoms, which then combine with oxygen molecules to form ozone molecules (O3).

As shown in FIG. 1 and FIG. 2, The dilution gas supplier 130 is connected to the dilution gas receiving vent 114, and the dilution gas supplier 130 is configured to supply a dilution gas to the dilution space. dilution gas is mixed with ozone in the dilution space to produce a low concentration ozone gas. Depending on the mass flow rate of ozone supplied by the ozone generator 120, the dilution gas supplier 130 supplies the dilution gas to the dilution space at a predetermined mass flow rate, such that a mass percentage concentration of the ozone in the low concentration ozone gas is less than a predetermined concentration, For example, the mass percentage concentration of ozone is less than 10%, but not limited to less than 10%.

As shown in FIG. 1 and FIG. 2, the dilution gas supplier 130 includes a dilution gas source and a mass flow controller 132. The dilution gas source is configured to supply the dilution gas, and the mass flow controller 132 is connected to the dilution gas source and the dilution gas receiving vent 114, to control the mass flow rate of the dilution gas flowing from the dilution gas source into the dilution space.

As shown in FIG. 1 and FIG. 2, dilution gas can be oxygen (O2) or argon (Ar). In the case where the dilution gas is oxygen (O2), the ozone generator 120 and the dilution gas supplier 130 may share the oxygen source S1, that is, the oxygen source S1 is also the dilution gas source for the dilution gas supplier 130. The oxygen source S1 provides oxygen to the ozone generator 120, and the mass flow controller is also connected to the same oxygen source S1 to use the oxygen provided by the oxygen source S1 as a dilution gas.

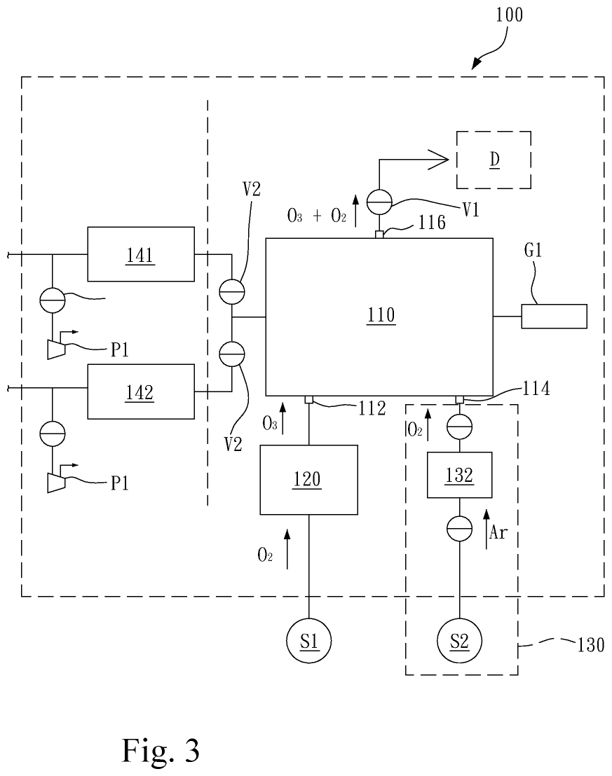

As shown in FIG. 3, When the dilution gas is argon gas (Ar), the mass flow controller 132 is connected to an argon gas source S2 and the argon gas source S2 is used as the dilution gas source. The argon source in FIG. 3 can be replaced by other gas source as long as the gas does not react easily with ozone and do not affect the surface properties of the wafers. The argon gas source S2 may also be another oxygen source, that is, the ozone generator 120 and the dilution gas supplier 130 are respectively connected to a different oxygen source instead of sharing the same oxygen source S1.

As shown in FIG. 2 and FIG. 3, specifically, the ozone generator 120 continuously supplies the ozone to the dilution space of ozone dilution tank 110, the dilution gas supply 130 continuously supplies dilution gas to the dilution space of the ozone dilution tank 110, and the low concentration ozone gas in the dilution space also continuously overflows through the overflow vent 116 to the ozone decomposition tank. Thus, the low concentration ozone gas is in a state of continuous replenishment and overflowing in the ozone dilution tank 110 to maintain the concentration and pressure of the low-concentration ozone gas. It should be noted that instead of supplying pure ozone gas, the ozone generator 120 supplies a mixture of ozone and oxygen gas.

As shown in FIG. 1, FIG. 2 and FIG. 3, the ozone dilution tank 110 is provided with an ozone pressure gauge G1. The ozone pressure gauge G1 is configured to monitor the pressure in the dilution space, so as to adjust the flow rate of ozone and dilution gas, and ensure that the pressure in the dilution space is larger than the pressure in the ozone decomposition tank D and the gas reservoirs 141, 142. Thus, contamination of the low concentration ozone gas by backflow of gas from the overflow vent 116 and/or the gas reservoirs 141, 142 is avoided. The overflow vent 116 may also be provided with a pressure relief valve V1, the pressure relief valve V1 opens when the pressure subjected is larger than a predetermined value, and pressure relief valve V1 closes when the pressure subjected is less than a predetermined value, again preventing external gases from flowing back into the dilution space from the overflow vent 116.

As shown in FIG. 1, FIG. 2 and FIG. 3, a plurality of gas reservoirs 141, 142 are each connected to the dilution space of the ozone dilution tank 110 via a gas inlet valve V2, and receive low concentrations ozone gas from the dilution space via the gas inlet valve V2. The gas inlet valve V2 can be closed in time to prevent gas from flowing back into the dilution space through the piping. In detail, the volume of the dilution space is larger than the sum of the volumes of the plurality of gas accumulators 141, 142 to ensure that the ozone dilution tank 110 can be supplied at all times with a sufficiently pressurized supply of low concentration ozone gas to the gas reservoirs 141, 142. Preferably, The volume of the dilution space is larger than the sum of the volumes of the plurality of gas reservoirs 141, 142 plus a margin, and the margin is larger than 10%, 20% or higher percentage of that sum.

As shown in FIG. 1, each of the gas reservoirs 141, 142 is connected to one corresponding reaction chamber 200 by an ozone supply pipe 150, for supplying a low concentration ozone gas to the corresponding reaction chamber 200. The ozone supply pipe 150 may be provided with an gas outlet valve V3 located between the reactor chamber and the corresponding gas reservoirs 141, 142. The gas outlet valve V3 is configured to timely open or close the supply of low concentration ozone gas to the reaction chamber 200. That is, in this embodiment, by selectively opening or closing the plurality of gas outlet valves V3, it is possible to supply the low concentration ozone gas to each of the reaction chambers 200 at the same time, or to supply the low concentration ozone gas to the individual reaction chambers 200 only.

In addition, in one embodiment, the volume size of the gas reservoirs 141, 142 and the length of the ozone supply pipe 150 affect the ozone concentration and flow rate. In order to achieve a consistent ozone concentration and flow rate received by each of the reaction chambers 200, The gas reservoirs 141, 142 have to be of the same volume size and the corresponding ozone supply lines 150 have to be of the same length. The middle section of the ozone supply pipe 150 may also be bypassed to a vacuum pump P1. Before starting the supply of low concentration ozone gas, the gas inlet valve V2 and gas outlet valve V3 can be closed at first and then the vacuum pump P1 can be started to evacuate the gas remaining inside the gas reservoirs 141, 142.

When supplying the low concentration ozone gas, the gas outlet valve V3 can be closed at first, so that the pressure of the low concentration ozone gas in the gas reservoirs 141, 142 is filled to the same pressure as the pressure of the ozone dilution tank 110, and then the gas outlet valve V3 can be opened again, so as to ensure that the concentration and the flow rate of the ozone supplied to the various reaction chambers 200 can be stabilized.

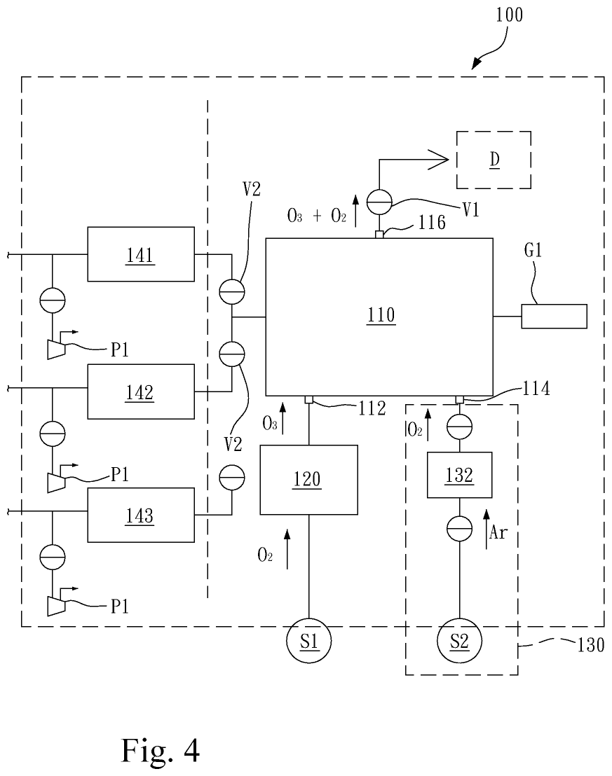

As shown in FIG. 4, two gas reservoirs 141, 142 are merely illustrative and may in fact be more than two, e.g. three gas reservoirs 141, 142, 143. Each of the gas reservoirs 141, 142, 143 is connected to a reaction chamber 200.

As shown in FIG. 1, The reaction chamber 200 can also be connected to different working gas sources via gas valves V4, V5 for subsequent CVD/ALD processes. For example gas valve V4 may be connected to a Trimethylaluminum (TMA) gas source to allow the reaction chamber 200 to receive TMA gas; the gas valve V5 may be connected to a nitrogen source to allow the reaction chamber 200 to receive nitrogen. The reaction chamber 200 may also be connected to a vacuum pump P2 to evacuate air from the reaction chamber 200 to maintain a low pressure inside the reaction chamber 200. A cold trap CT may be provided between the reaction chamber 200 and the vacuum pump P2 to collect substances with a high condensation point in the gas. A vacuum pressure gauge G2 can be installed between the cold trap CT and the vacuum pump P2 to monitor the pressure change after the vacuum pump P2 is operated. A shut-off valve V6 can be provided between the cold trap CT and the vacuum pump P2 to close the line when the vacuum pump P2 is stopped. The reaction chamber 200 can also be connected to a chamber pressure gauge G3 via a shut-off valve V7 to monitor the pressure inside the reaction chamber 200.

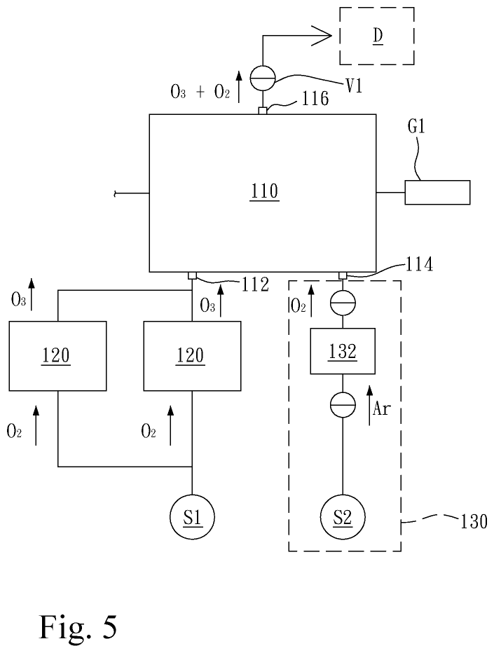

As shown in FIG. 5, If the ozone production from the ozone generator 120 is insufficient, the low concentration ozone gas supply device 100 may be equipped with a plurality of ozone generators 120 connected to the ozone dilution tank 110 individually, or in combination, to the ozone dilution tank 110 to ensure sufficient ozone supply.

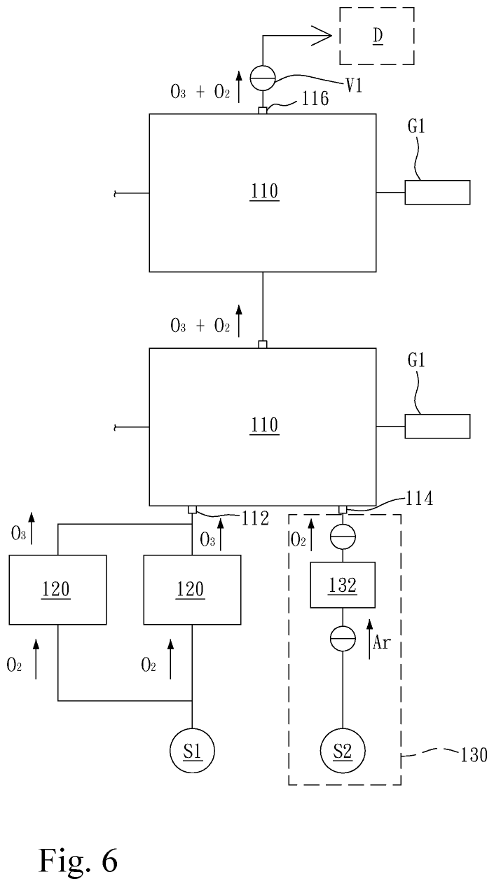

As shown in FIG. 6, If the capacity of the ozone dilution tank 110 is insufficient, such as when the capacity of a single ozone dilution tank 110 is less than the sum of the volumes of the plurality of gas accumulators 141, 142, or when the capacity of the dilution space is less than the sum of the volumes of the plurality of gas accumulators 141, 142, then the low concentration ozone gas supply device 100 may be equipped with a plurality of ozone dilution tanks 110. The plurality of ozone dilution tanks 110 are interconnected to equalize the pressure of the ozone gas as well as the ozone concentration. Plural ozone dilution tanks 110 may be configured in series, with a single ozone dilution tank 110 receiving ozone and dilution gas, and a single ozone dilution tank 110 outputting a low concentration of ozone gas. A plurality of ozone dilution tanks 110 can be configured in parallel, whereby ozone and dilution gases are simultaneously injected into the plurality of ozone dilution tanks 110, and the low-concentration ozone gases output from the plurality of ozone dilution tanks 110 are combined by manifolds and then diverted to the respective gas reservoir 141, 142.

With the low concentration ozone gas supply device 100 proposed by this disclosure, the ozone and dilution gas are first fully mixed in the ozone dilution tank 110 to form a low concentration ozone gas, and then the low concentration ozone gas is used to pressurize the gas reservoirs 141, 142. The gas reservoirs 141, 142 ensure that the low concentration ozone gas injected into the reactor chamber maintains a stable concentration and flow rate, so that the process conditions (e.g., wafer cleaning time and temperature) in the reaction chamber can be more easily controlled, and good process results can be maintained.

What is claimed is:

1. A low concentration ozone gas supply device for supplying low concentration ozone gas to a plurality of reaction chambers, comprising:
an ozone dilution tank provided with a dilution space defined therein, and the ozone dilution tank being provided with an overflow vent connected to the dilution space;
an ozone generator, configured to continuously supply ozone to the dilution space of the ozone dilution tank;
a dilution gas supplier, configured to supply a dilution gas to the dilution space, wherein the ozone is mixed with the dilution gas in the dilution space to form the low concentration ozone gas, and the low concentration ozone gas in the dilution space continuously overflows via the overflow vent; and
a plurality of gas reservoirs, connected to the dilution space for respectively receiving the low concentration low concentration; wherein
the volume of the dilution space is larger than the sum of the volumes of the gas reservoirs.

2. The low concentration ozone gas supply device as claimed in claim 1, wherein the ozone dilution tank is provided with an ozone receiving vent, and the ozone generator is connected to the ozone receiving vent.

3. The low concentration ozone gas supply device as claimed in claim 2, wherein the ozone generator is connected to an oxygen source for receiving oxygen, and the ozone generator provides a high-voltage electric field within the ozone generator to convert the oxygen into ozone.

4. The low concentration ozone gas supply device as claimed in claim 1, wherein the ozone dilution tank includes a dilution gas receiving vent and the dilution gas supply is connected to the dilution gas receiving vent.

5. The low concentration ozone gas supply device as claimed in claim 1, wherein depending on the mass flow rate of ozone supplied by the ozone generator, the dilution gas supplier supplies the dilution gas to the dilution space at a predetermined mass flow rate, such that a mass percentage concentration of the ozone in the low concentration ozone gas is less than 10%.

6. The low concentration ozone gas supply device as claimed in claim 5, wherein the dilution gas supplier includes a dilution gas source and a mass flow controller, the dilution gas source is configured to supply the dilution gas, and the mass flow controller is connected to the dilution gas source to control the mass flow rate of the dilution gas flowing from the dilution gas source into the dilution space.

7. The low concentration ozone gas supply device as claimed in claim 6, wherein the dilution gas is oxygen, the dilution gas source of the dilution gas supplier is an oxygen source, and the ozone generator receives oxygen from the oxygen source.

8. The low concentration ozone gas supply device as claimed in claim 1, wherein the ozone dilution tank is provided with an ozone pressure gauge. configured to monitor the pressure in the dilution space so as to adjust the flow rate of ozone and dilution gas.

9. The low concentration ozone gas supply device as claimed in claim 1, wherein the volume of the dilution space is larger than the sum of the volumes of the gas reservoirs plus a margin, and the margin is larger than 10% of that sum.
The low concentration ozone gas supply device as claimed in claim 1, wherein each of the gas reservoirs is connected to one corresponding reaction chamber by an ozone supply pipe, for supplying a low concentration ozone gas to the corresponding reaction chamber, and each of the gas reservoirs is of the same volume size and each of the corresponding ozone supply lines is of the same length.
